(19) United States
(12) Patent Application Publication
(10) Pub. No.: US 2015/0076076 A1
(43) Pub. Date: Mar. 19, 2015

(54) SYSTEM FOR REMOVAL OF SUSPENDED SOLIDS AND DISINFECTION OF WATER

(71) Applicant: ORIGINOIL, INC., Los Angeles, CA (US)

(72) Inventors: William Charneski, Santa Monica, CA (US); Nicholas Eckelberry, Los Angeles, CA (US); Dave Anderson, El Segundo, CA (US)

(73) Assignee: ORIGINOIL, INC., Los Angeles, CA (US)

(21) Appl. No.: 14/543,457

(22) Filed: Nov. 17, 2014

Related U.S. Application Data
(63) Continuation-in-part of application No. 13/942,348, filed on Jul. 15, 2013.

(51) Int. Cl. C02F 1/465; C02F 1/467

(52) U.S. Cl. CPC C02F 1/465; C02F 1/4674; C02F 2201/46105
USPC 210/704; 210/192

(57) ABSTRACT

A system for removal of suspended solids and disinfection of an aqueous medium by electrolysis is disclosed. The system comprises a plurality of electrode assemblies configured to generate hydrogen gas and halides. Each electrode assembly comprises an inner electrode made of a non-donating conductive material and an outer electrode configured to sheath the inner anode. The outer electrode comprises a conductive material and a plurality of apertures. Power is supplied to the electrode assemblies and electrolysis occurs to generate hydrogen gas and halides. The halides disinfect the aqueous medium and the hydrogen gas entrains suspended solids to the surface of the aqueous medium. The suspended solids are removed from the surface of the aqueous medium.

### CROSS-REFERENCE TO RELATED APPLICATIONS

This application is a continuation-in-art of U.S. patent application Ser. No. 13/942,348 (Attorney Docket No. 18990.63), filed on Jul. 15, 2013, titled “Removing Ammonia From Water,” which is a continuation-in-part of U.S. patent application Ser. No. 13/872,044 (Attorney Docket No. 18990.62), filed on Apr. 26, 2013, titled “Producing Algae Biomass Having Reduced Concentration Of Contaminants,” which is a continuation-in-part of U.S. patent application Ser. No. 13/865,097 (Attorney Docket No. 18990.60), filed Apr. 17, 2013, titled “Harvesting And Dewatering Algae Using A Two-Stage Process,” which is a continuation-in-part of U.S. patent application Ser. No. 13/753,484 (Attorney Docket No. 18990.58), filed Jan. 29, 2013, titled “Systems And Methods For Harvesting And Dewatering Algae,” which claims priority to U.S. Provisional Patent Application No. 61/592,522 (Attorney Docket No. 18990.44), filed Jan. 30, 2012, titled “Systems And Methods For Harvesting And Dewatering Algae.”

U.S. patent application Ser. No. 13/865,097 also claims priority to U.S. Provisional Patent Application No. 61/625,463 (Attorney Docket No. 18990.47), filed Apr. 17, 2012, titled “Solute Extraction From An Aqueous Medium Using A Modular Device,” and to U.S. Provisional Patent Application No. 61/649,083 (Attorney Docket No. 18990.48), filed May 28, 2012, titled “Modular Systems And Methods For Extracting A Contaminant From A Solution.” This application claims the benefit of these two provisional applications.

The disclosures of each of the applications to which the present application claims priority are incorporated by reference.

### BACKGROUND

Many industrial processes result in water that may contain any number of materials including, but not limited to solutes, suspended materials, organic matter, oil, gas, bacteria, inorganic contaminants, and other contaminants. A number of techniques have been developed to remove these materials from the water. Some techniques employ a holding tank in which the water is allowed to separate from the materials based on differences in density between the water and the materials. Less dense materials such as oil and gas separate from the water into layers above the water layer. These upper layers can then be removed or the water layer can be removed from below. In some variations of these techniques, the separation of materials from water is aided by air bubbles pumped into the water layer. The air bubbles float upward through the tank and aid in the separation of materials from the water layer. In some techniques, the air bubbles aid in the separation of suspended materials by entraining the suspended materials and causing the suspended materials to rise to the surface. Once at the surface, these suspended materials can then be removed. While air is usually used for this process, other gases, such as hydrogen can be used to facilitate the removal of the materials. There are a variety of ways to generate gases for these processes, including electrolysis.

One technique for the electrolytic generation of gases employs an array comprising a plurality of anode and cathode plates arranged in parallel, alternating fashion. The array of plates is immersed in an aqueous medium and connected to a direct current power supply. Electrolysis occurs when a direct current is applied across the plates and creates anodic reactions and cathodic reactions. These anodic reactions and cathodic reactions produce gases and ions. The types of generated gases and ions depend on the composition of the anodic plates, composition of the cathodic plates, composition of the aqueous medium, and on the direct current applied.

One particular technique that is commonly used for electrolysis is described in U.S. Pat. No. 8,282,812. This technique employs the parallel plate array described above and uses anode plates comprising zinc and cathode plates comprising aluminum. This parallel plate array is assembled as a monolithic unit that is immersed in a salt water solution. Direct current is then applied to the parallel plate array and hydrogen gas is produced. The parallel plate array is configured such that the gap between the anode plates and the cathode plates is restricted to between 0.03 and 0.100 inches to achieve increased levels of hydrogen gas generation.

Although parallel plate array techniques as described above can generate gas, these techniques suffer from a number of drawbacks. One problem is that generated gases tend to accumulate between plates and create dead zones that prevent electrolysis from occurring at these dead zones. Another drawback is that the parallel plates comprise donating materials that are converted into metal ions during the process of electrolysis, leading to decay of the plates and requiring regular replacement of the plates. Furthermore, metal ions may contaminate the aqueous medium, requiring additional treatment of the aqueous medium to remove the metal ions. Lastly, the decay of the parallel plates can be uneven and lead to short circuits and inefficient electrolysis.

A final issue with the separation of materials from the water is that the materials may comprise bacteria and other microorganisms. Therefore, because these bacteria and other microorganisms may be harmful, an additional step of disinfecting the water is required as part of the total process of removing the materials from the water.

### BRIEF SUMMARY

The present invention is generally directed to employing an array of electrode assemblies to remove suspended solids from water and to disinfect water. The electrode assemblies are configured with an inner electrode and an outer electrode. The inner electrode comprises a non-donating material and the outer electrode comprises a plurality of apertures. The electrode assemblies are immersed in the water to be treated. Power is supplied to the electrode assemblies and electrolysis generates hydrogen gas and halides. The generated halides disinfect the water to be treated and the hydrogen gas entrains suspended solids to the surface of the water. The suspended solids are then removed from the surface of the water.

In one embodiment, the electrode assembly for the generation of hydrogen gas and halides by electrolysis comprises an inner electrode, an outer electrode, and a power supply. The inner electrode comprises a non-donating conductive material. The outer electrode is configured to sheath the inner anode. The outer electrode comprises a conductive material and is configured with a plurality of apertures. The power supply is configured to supply a voltage differential to the inner electrode and the outer electrode. The outer electrode sheaths the inner electrode such that a spacing exists between the outer electrode and the inner electrode. The outer electrode and the inner electrode are configured to be in physical contact with an aqueous medium.

In another embodiment, the invention includes a system for removal of suspended solids and disinfection of an aqueous medium by electrolysis. The system comprises a plurality of electrode assemblies configured to generate hydrogen gas and halides. Each electrode assembly comprises an inner electrode comprising a non-donating conductive material and an outer electrode configured to sheath the inner anode. The outer electrode comprises a conductive material and is configured with a plurality of apertures. The outer electrode sheaths the inner electrode such that a spacing exists between the outer electrode and the inner electrode. The system also includes a power supply configured to supply a voltage differential to the plurality of electrode assemblies. An aqueous medium is in physical contact with the plurality of electrode assemblies. The system also includes a precipitate removal system configured to remove suspended solids from the surface of the aqueous medium, the suspended solids having been entrained to the surface of the aqueous medium by hydrogen gas.

In yet another embodiment, the present invention includes a method for removal of suspended solids and disinfection of an aqueous medium by electrolysis. First, the method comprises providing a plurality of electrode assemblies configured to generate hydrogen gas and halides. Each electrode assembly comprises an inner electrode comprising a non-donating conductive material and an outer electrode configured to sheath the inner anode. The outer electrode comprises a conductive material and a plurality of apertures. The outer electrode sheaths the inner electrode such that a spacing exists between the outer electrode and the inner electrode. Second, the method includes contacting an aqueous medium with the plurality of electrode assemblies. The aqueous medium comprises suspended solids. Third, the method includes generating hydrogen gas and halides within the aqueous medium by supplying a voltage differential to the inner electrode and the outer electrode in the plurality of electrode assemblies. Fourth, the method includes disinfecting the aqueous medium with the halides. Fifth, the method includes entraining suspended solids to a surface of the aqueous medium with the hydrogen gas. Lastly, the method includes removing suspended solids from the surface of the aqueous medium.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a side view of an electrode for generating hydrogen gas and halides by electrolysis;

FIG. 1B illustrates a cross-sectional view of an electrode for generating hydrogen gas and halides by electrolysis;

FIG. 2 illustrates a perspective view of an electrode for generating hydrogen gas and halides by electrolysis;

FIG. 3 illustrates an electrode array for generating hydrogen gas and halides by electrolysis;

FIG. 4 illustrates a system for removal of suspended solids and disinfection of water;

FIG. 5 illustrates a double-vessel system for removal of suspended solids and disinfection of water; and

FIG. 6 illustrates a method for removal of suspended solids and disinfection of water.

### DETAILED DESCRIPTION

The present disclosure is generally directed to a system and methods for removal of suspended solids in water with concomitant disinfection of the water by halides. The system employs electrolysis to generate both hydrogen gas and halides in the water. The generated hydrogen gas bubbles through the water and assists in the removal of the suspended solids by entraining the suspended solids and causing the suspended solids to rise to the surface of the water. The suspended solids on the surface of the water can then be removed. The generated halides disperse throughout the water and interact with bacteria and other microorganisms to disinfect the water.

The technique of electrolysis is used to generate the hydrogen gas and halides. Electrolysis of an electrically-conductive aqueous solution can produce both hydrogen and halogen gases as reaction products from solutions containing dissolved metal halides. Halogen gases include chlorine gas, fluorine gas, bromine gas, and iodine gas. Dissolved metal halides include NaCl, CaCl₂, MgCl₂, CaSO₄, Na₂SO₄, MgBr₂, and NaBr. Equation 1 illustrates how electrolysis of an aqueous solution of a metal halide containing sodium can produce a halogen gas and a hydrogen gas.

2NaX_{(aq)}+2H₂O_{(I)}→X_{2(g)}+2NaOH_{(aq)}+H_{2(g)}, where X=halogen species Equation 1:

In this example, the halogen gas forms at the anode and the hydrogen gas forms at the cathode. In addition, a small amount of hydroxide ions can dissociate at the anode and provide a small amount of by-product oxygen gas as shown in Equation 2.

4OH⁻_{(aq)}→2H₂O_{(I)}+O_{2(g)} Equation 2:

If hydrogen gas and halogen gas recombine at any point, the two gases can form a hydrogen-halogen gas as shown in Equation 3, which in the aqueous solution environment can then form an acidic solution as shown in Equation 4:

H_{2(g)}+X_{2(g)}→2HX_{(g)} Equation 3:

HX_{(g)}+H₂O_{(g)}→H₂O_{(I)}+Cl⁻_{(g)} Equation 4:

The present application further discloses a system and method for generating hydrogen gas and halides in an aqueous medium by electrolysis with electrode assemblies. The electrode assemblies comprise a non-metal ion donating (non-donating) inner electrode sheathed by an outer electrode. The outer electrode is configured with apertures to optimize electrolysis and to minimize dead zones caused by accumulation of hydrogen gas. The electrode assembly is brought into contact with the aqueous medium and electrolysis is begun by supplying a voltage differential to the inner electrode and outer electrode. Electrolysis generates hydrogen gas and halides to remove suspended solids and disinfecting the aqueous medium as described above. The electrode assemblies may be configured into arrays by fixing a plurality of units into a nonconductive frame. The array of electrode assemblies can be positioned within the aqueous medium for optimal effect or multiple arrays of electrode assemblies can be positioned within the aqueous medium for optimal effect. The decay of the electrodes is avoided by the use of non-donating electrodes thereby reducing the need to replace electrodes and the need to remove decayed metal ions in the aqueous medium.

However, the present application can also be implemented in other more general systems. An example of such a system is provided below.

System for Removal of Suspended Solids and Disinfection of Water

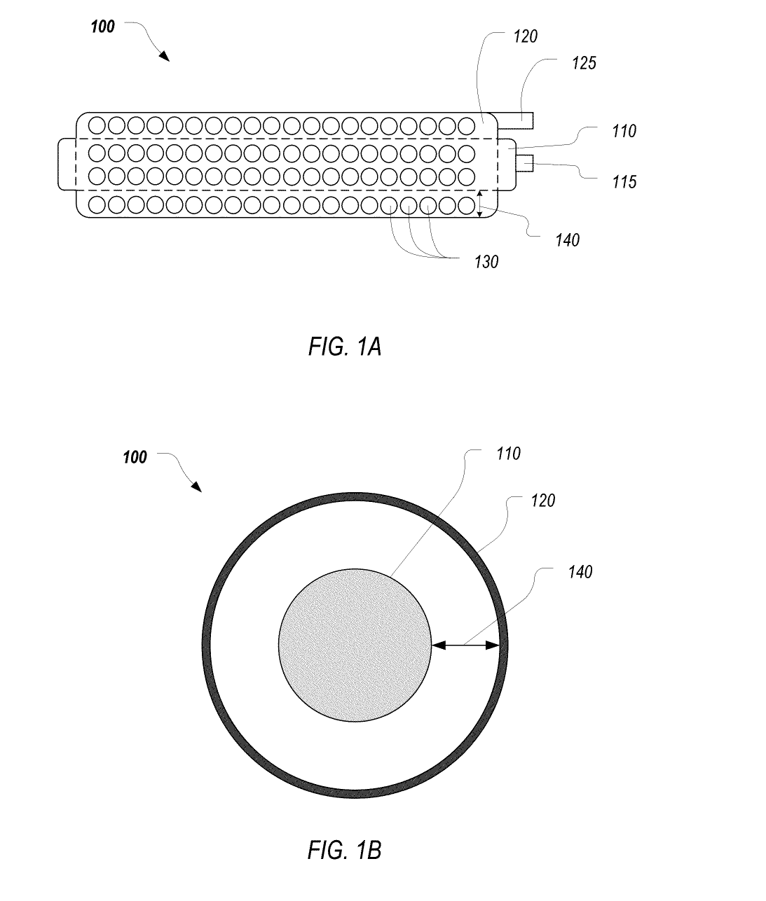

FIGS. 1A and 1B illustrate side and cross-sectional views of an example electrode assembly 100. As shown in FIG. 1A, the electrode assembly 100 comprises an inner electrode 110 and an outer electrode 120 that is configured to sheath the inner electrode 110. The outer electrode 120 comprises a plurality of apertures 130. The inner electrode 110 and the outer electrode 120 are configured such that a spacing 140 is maintained between the inner electrode 110 and the outer electrode 120. The inner electrode 110 further comprises and inner electrode connector 115 configured to be connected to a power supply. The outer electrode 120 further comprises an outer electrode connector 125 configured to be connected to a power supply. FIG. 1B shows a cross-sectional view of the electrode assembly 100. Cross-sectional views of the inner electrode 110, the outer electrode 120, and the spacing 140 are visible.

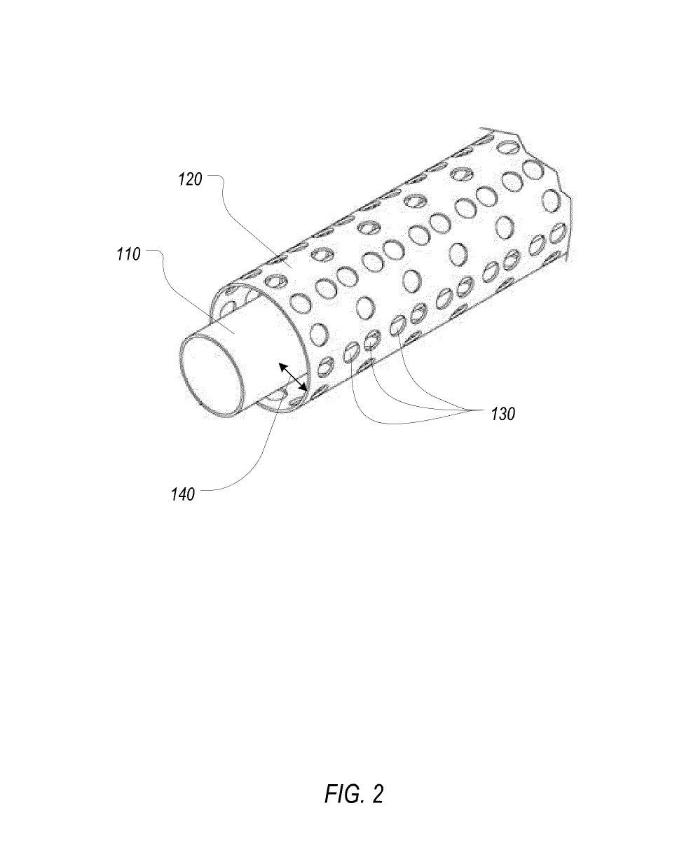

FIG. 2 illustrates a perspective view of an example electrode assembly 100. The inner electrode 110, the outer electrode 120, plurality of apertures 130 and the spacing 140 are visible.

In this example embodiment, both the inner electrode 110 and the outer electrode 120 are configured with a nested cylinder arrangement. The inner electrode 110 is configured as an anode and comprises a non-donating conductive material. This non-donating conductive material comprises a noble metal such as platinum, ruthenium, rhodium, palladium, osmium, iridium, or combinations thereof. The outer electrode 120 is configured as a cathode and comprises stainless steel or similar material. The apertures 130 comprise a pattern of round holes in the outer electrode 120. The spacing 140 ranges from about 1 mm to about 9 mm.

In some embodiments, the spacing 140 can range from about 0.05 mm to about 15 mm. In other embodiments, the spacing 140 can range from about 0.1 mm to about 12 mm. In alternate embodiments, the spacing 140 can range from about 0.1 mm to about 10 mm. In yet other embodiments, the spacing 140 can range from about 1 mm to about 5 mm.

In other embodiments, the inner electrode 110 and the outer electrode 120 are configured with a nested cylinder arrangement, with the inner electrode 110 configured as a cylinder that is centrally positioned within the outer electrode 120, the outer electrode 120 also configured as a cylinder. In some embodiments, the inner electrode 110 is configured as a rectangular solid with a cross-sectional shape of a square and with the outer electrode 120 similarly configured. In alternate embodiments, the inner electrode 110 and the outer electrode 120 are configured as a solid shape with a trapezoidal cross-section. In yet another embodiment, the inner electrode 110 is configured as a plurality of electrodes that are sheathed by the outer electrode 120. In some embodiments, the inner electrode 110 is not centrally positioned within the outer electrode 120. In other embodiments, the inner electrode 110 is configured as an elongated flat sheet. In another embodiment, the inner electrode 110 is configured as a curved sheet. In alternate embodiments, the inner electrode 110 is configured as a cylinder with an ellipsoid cross-section.

In some embodiments the inner electrode 110 is configured as an anode and the outer electrode 120 is configured as a cathode. In another embodiment, the inner electrode 110 is configured as a cathode and the outer electrode is configured as an anode.

In some embodiments, the inner electrode 110 comprises a solid support substrate core coated with a non-donating material. In other embodiments, the inner electrode 110 comprises a hollow support substrate core coated with a non-donating material.

In some embodiments, the outer electrode 120 comprises a core coated with a donating material. In other embodiments, the outer electrode 120 comprises a donating material. In alternate embodiments, the outer electrode 120 comprises a non-donating material. In yet other embodiments, the outer electrode 120 comprises a support substrate core coated with a non-donating material.

In some embodiments, the anode material comprises a non-donating conductive material such as a noble metal including platinum, ruthenium, rhodium, palladium, osmium, iridium, or combinations thereof. In other embodiments, the anode material may comprise materials such as Ti. In alternate embodiments, the anode material may comprise carbon or conductive plastics such as polyethyne. In yet other embodiments, the anode material may comprise any donating metal sufficient to promote electrolysis. In some embodiments, the anode material may comprise a ceramic coated with and/or embedded with a non-donating conductive material.

In some embodiments, the cathode material comprises noble metals such as platinum, ruthenium, rhodium, palladium, osmium, iridium, or combinations thereof. In other embodiments, the cathode material comprises stainless steel. In yet other embodiments, the cathode material may comprise any donating metal sufficient to promote electrolysis. In another embodiment, the cathode material comprises carbon or a conductive plastic such as polyethyne. In some embodiments, the cathode material may comprise a ceramic coated with and/or embedded with a non-donating conductive material.

In some embodiments, the apertures 130 comprise circular cutouts in the outer electrode 120. In other embodiments, the apertures 130 comprise cutouts of other shapes. In alternate embodiments, the apertures 130 are configured in size and density to avoid dead zones and allow for release of gas at certain voltages, amperages, and currents. In another embodiment, the apertures may be configured as a mesh, screen, or braided arrangement.

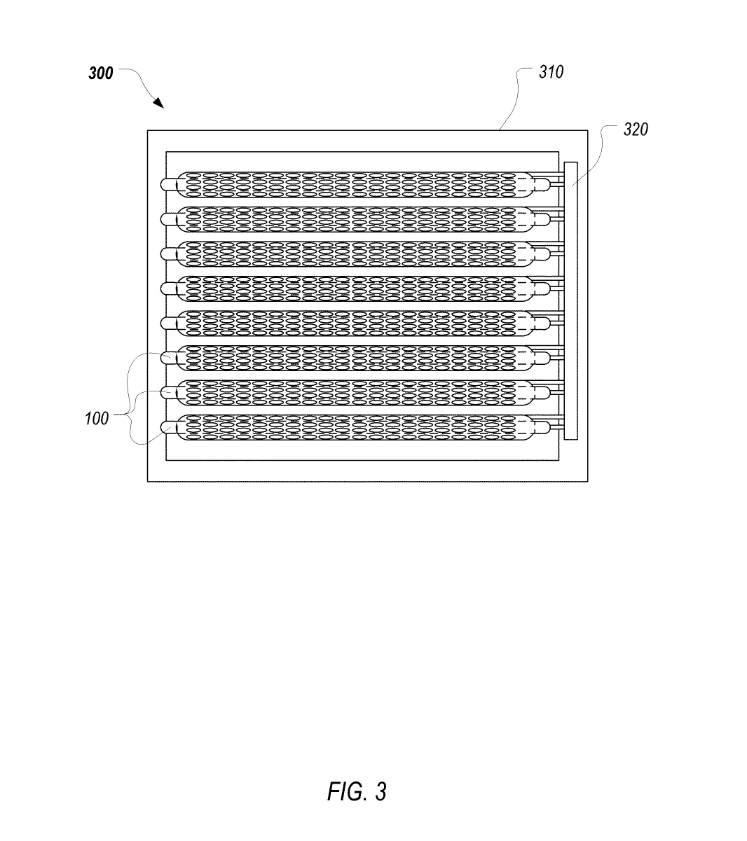

FIG. 3 illustrates an example electrode array 300 comprising a nonconductive frame 310 configured to secure a plurality of electrodes 100. The electrode array 300 further comprises a connector system 320 configured to connect the inner electrode connectors 115 and the outer electrode connectors 125 of the plurality of electrodes 100. The connector system is configured to electrically connect the plurality of electrodes 100 in parallel. In some embodiments, the nonconductive frame 310 is configured to secure the plurality of electrodes 100 in a planar configuration. In other embodiments, the nonconductive frame 310 is configured to secure the plurality of electrodes 100 in other configurations that minimize dead zones and maximize release of gas. In alternate embodiments, the nonconductive frame 310 can comprise other suitable nonconductive materials such as plastic, epoxy, fiberglass, glass, ceramics and rubber. In another embodiment, the connector system 320 is configured to electrically connect the plurality of electrodes 100 in series. In yet another embodiment, the electrode array 300 is configured such that individual electrodes 100 can be easily removed and replaced within the electrode array 300.

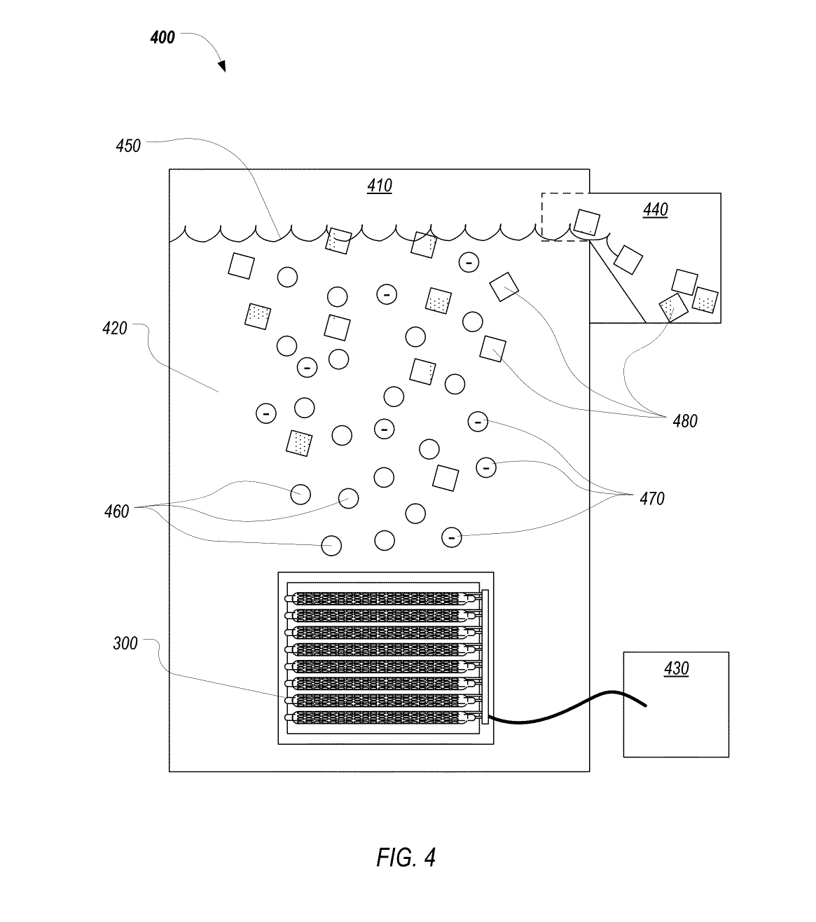

FIG. 4 illustrates an example system 400 for removal of suspended solids and disinfection of water. The system 400 comprises a vessel 410, one or more electrode arrays 300, an aqueous medium 420, a power supply 430, and a precipitate removal system 440. The vessel 410 is configured to contain the aqueous medium 420. In some embodiments, the vessel 410 is also electrically insulated from the surrounding environment. The one or more electrode arrays 300 are immersed in the aqueous medium 420 and can be secured on the side or bottom of the vessel 410. The aqueous medium 420 comprises water with suspended solids and bacteria and other microorganisms. The electrode array 300 is electrically connected to the power supply 430. The precipitate removal system 440 is configured to work as a protein skimmer to remove floating precipitated solids from the surface of the aqueous medium 450. In this example the precipitate removal system 440 is configured to attach to the side of the vessel 410 and to be flush with the surface of the aqueous medium 450.

The system 400 is employed by electrically energizing the array of electrodes 300 with the power supply 430 to activate electrolysis. As electrolysis is activated the electrodes 100 interact with the aqueous medium 420 to produce hydrogen gas 460 and halides 470. As the hydrogen gas 460 rises through the aqueous medium 420 the suspended solids are converted into precipitated solids 480 and are entrained to the surface 450. The precipitated solids 480 on the surface 450 are then removed by the precipitate removal system 440. The produced halides 470 disperse throughout the aqueous medium 420 to disinfect the aqueous medium 420 of any bacteria or microorganisms. Electrolysis continues until satisfactory removal of total suspended solids and satisfactory disinfection of the aqueous medium 420 has occurred. The resulting treated aqueous medium 420 is then removed. The one or more electrode arrays 300 of the system are configured to allow for easy removal and/or replacement of individual electrode arrays 300 or easy removal and/or replacement of individual electrodes 100.

In some embodiments, the aqueous medium 420 is produced water from petroleum mining, natural gas mining operations, or hydraulic fracturing operations. In other embodiments, the aqueous medium 420 is growth medium from algae growing operations. In yet other embodiments, salts, ions, or other additives are added to the aqueous medium 420 prior to electrolysis. In alternate embodiments, salts, ions, or other additives are added to the aqueous medium 420 prior to electrolysis to adjust the conductivity of the aqueous medium 420. In another embodiment, the aqueous medium 420 may be modified with surface acting agents or coagulants to encourage a more rapid flocculation of the solids for faster recovery.

In some embodiments, the precipitate removal system 440 comprises a protein skimmer equipped with a belt or rake system. In other embodiments, the belt or rake system comprises one or more scrapers that remove the precipitated solids from the belt or rake. In alternate embodiments, the precipitate removal system 440 comprises a plurality of protein skimmers. In other embodiments, the precipitate removal system 440 may include a weir system which entrains the solids utilizing the movement of fluids at the surface of the vessel. The solids, may be disposed of in a separate containment tank. In other embodiments, the system can include a vacuum system that aspirates the solids from the surface of the water.

In other embodiments, the system 400 is configured as a monolithic unit with a single vessel 410 with the other accompanying system components. In some embodiments, the system 400 is configured to operate in a continuous flow fashion with aqueous medium 420 entering the system and treated aqueous medium exiting the system. In alternate embodiments, the system 400 is configured with two or more vessels 410 and accompanying system components. Aqueous medium 420 enters the first vessel 410 and receives preliminary treatment and removal of suspended solids and disinfection of bacteria and other microorganisms. The treated aqueous medium 420 then passes to the remaining vessels 410 for further treatment to remove remaining suspended solids and disinfection of bacteria and other microorganisms. In yet other embodiments, the system 400 further comprises additional pumps, impellers, propellers and/or other liquid moving devices to satisfactorily circulate the aqueous medium 420, transfer the aqueous medium 420, and/or disperse the produced hydrogen gas 460 and produced halides 470.

In alternate embodiments, the system 400 is configured as a portable modular unit that can be inserted into and used in pre-existing vessels 410. For example, such portable modular systems 400 can be used in place of or in conjunction with conventional water treatment systems such as gun barrel systems, microbubble systems, and dissolved air flotation systems. Other portable systems 400 can be used as part of a larger water treatment system. Other portable modular systems 400 can be configured such that the system 400 can move throughout the larger vessel 410 or be set at various locations and/or depths within the vessel 410. Other portable modular systems 400 can be configured such that more than one of the systems 400 can be used in a single vessel 410.

In some embodiments the power supply 430 provides direct current. In other embodiments the power supply 430 is configured to vary the voltage, amperage, and current to vary the amount and efficiency of electrolysis. The voltage, amperage, and current can be varied in accordance with the electrode materials, conductivity of the aqueous medium 420, composition of the aqueous medium, size of the vessel 410, and desired level of removal of suspended solids and disinfection of bacteria and other microorganisms.

In other embodiments, the temperature, pressure, and/or pH of the aqueous medium 420 is varied to achieve the desired level of removal of suspended solids and disinfection of bacteria and other microorganisms. In another embodiment, the system 400 further comprises sensors to monitor and/or adjust temperature, pressure, pH, dissolved oxygen, dissolved gases, dissolved solids, and/or conductivity.

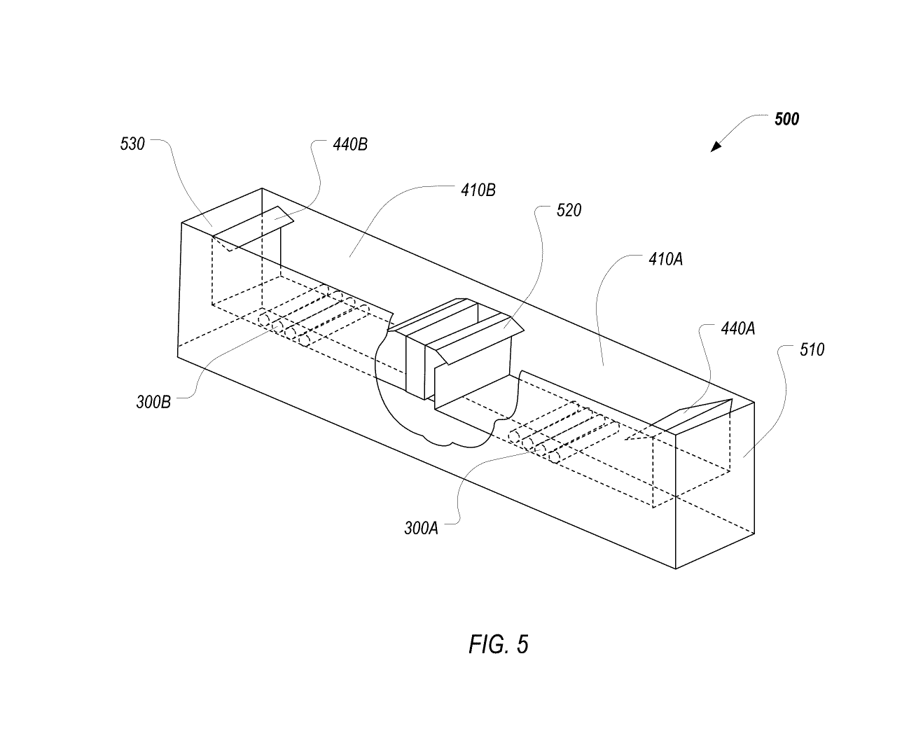

FIG. 5 illustrates an example embodiment of a system 400 for removal of suspended solids and disinfection of water. The example system illustrated comprises a double tank configuration with aqueous medium 420 entering a first vessel 410A. A first electrode array 300A is electrically energized, generating hydrogen gas 460 and halides 470. The halides 470 disinfect the aqueous medium 420. Precipitated solids 480 are produced from the dissolved solids and entrained to the surface 450. A first precipitate removal system 440A removes the precipitated solids 480 and deposits the precipitated solids 480 into a first cavity 510. The treated aqueous medium then passes via a weir 520 to a second vessel 410B. The electrolyzing process is repeated with a second electrode array 300B generating hydrogen gas 460 and halides 470. Precipitated solids 480 are produced from the dissolved solids and entrained to the surface 450. The halides 470 further disinfect the aqueous medium 420. A second precipitate removal system 440B removes the precipitated solids and deposits the precipitated solids 480 into a second cavity 530. The doubly treated aqueous medium is then removed from the vessel 410B for use or for further processing. It is understood that the representational drawings show a two tank configuration, however there can be a plurality of tanks in sequence and the representational drawing does not limit the number of tanks.

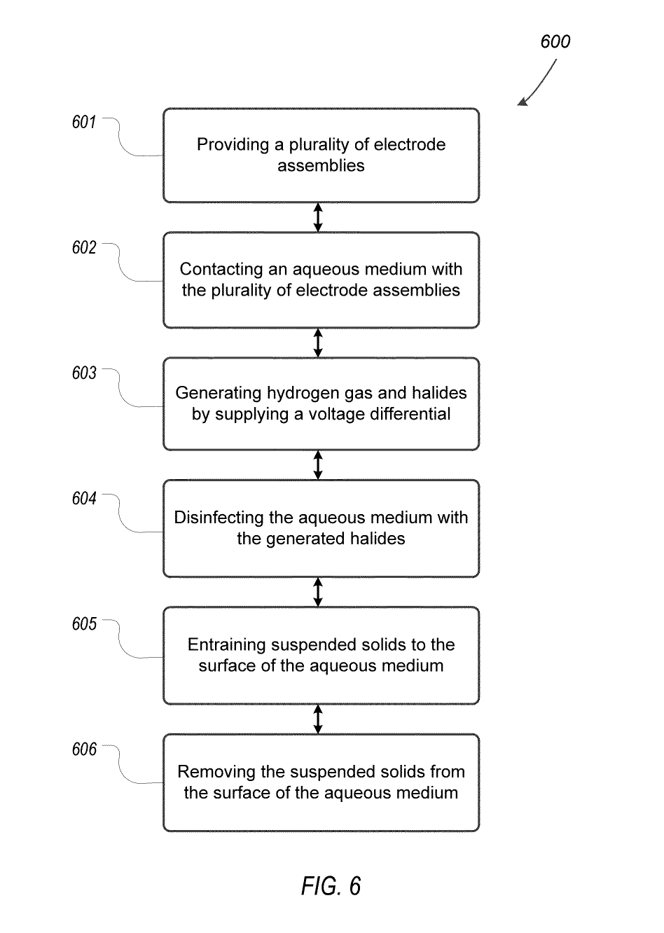

FIG. 6 illustrates a method 600 for removal of suspended solids and disinfection of water. The method 600 comprises Steps 601 through 606. Step 601 includes providing a plurality of electrode assemblies configured to generate hydrogen gas and halides. Each electrode assembly comprises an inner electrode comprising a non-donating conductive material and an outer electrode configured to sheath the inner anode. The outer electrode comprises a conductive material and is configured with a plurality of apertures. The outer electrode sheaths the inner electrode such that a spacing exists between the outer electrode and the inner electrode. Step 602 includes contacting an aqueous medium with the plurality of electrode assemblies. The aqueous medium can comprise suspended solids and bacteria or other microorganisms. Step 603 includes generating hydrogen gas and halides within the aqueous medium by supplying a voltage differential to the inner electrode and the outer electrode in the plurality of electrode assemblies. Step 604 includes disinfecting the aqueous medium with the generated halides. Step 605 includes entraining suspended solids to the surface of the aqueous medium with the hydrogen gas. Step 606 includes removing suspended solids from the surface of the aqueous medium. The suspended solids or precipitated solids can be removed with a precipitate removal system such as a protein skimmer. The treated aqueous medium can then be used or processed further.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. An electrode assembly for the generation of hydrogen gas and halides by electrolysis, the electrode assembly comprising:
an inner electrode comprising a non-donating conductive material;
an outer electrode configured to sheath the inner anode, the outer electrode comprising a conductive material, and the outer electrode configured with a plurality of apertures; and
a power supply configured to supply a voltage differential to the inner electrode and the outer electrode;
wherein the outer electrode sheaths the inner electrode such that a spacing exists between the outer electrode and the inner electrode,
wherein the outer electrode and the inner electrode are configured to be in physical contact with an aqueous medium.

2. The electrode assembly of claim 1, wherein the non-donating material of the inner electrode further comprises platinum, ruthenium, rhodium, palladium, osmium, iridium, or combinations thereof.

3. The electrode assembly of claim 1, wherein the non-donating material of the inner electrode further comprises titanium, carbon, conductive plastic or combinations thereof.

4. The electrode assembly of claim 1, wherein the inner electrode comprises a support substrate coated with a non-donating conductive material.

5. The electrode assembly of claim 1, wherein the outer electrode comprises stainless steel.

6. The electrode assembly of claim 1, wherein the outer electrode comprises a non-donating conductive material.

7. The electrode assembly of claim 1, wherein the non-donating material of the outer electrode further comprises platinum, ruthenium, rhodium, palladium, osmium, iridium, or combinations thereof.

8. The electrode assembly of claim 1, wherein the non-donating material of the outer electrode further comprises, titanium, carbon, conductive plastic, or combinations thereof.

9. The electrode assembly of claim 1, wherein the apertures of the outer electrode are configured as a mesh.

10. The electrode assembly of claim 1, wherein the inner electrode is configured as an anode and the outer electrode is configured as a cathode.

11. The electrode assembly of claim 1, wherein the spacing is between about 1 mm to about 9 mm.

12. A system for removal of suspended solids and disinfection of an aqueous medium by electrolysis, the system comprising:
a plurality of electrode assemblies configured to generate hydrogen gas and halides, each electrode assembly comprising:
an inner electrode comprising a non-donating conductive material; and
an outer electrode configured to sheath the inner anode, the outer electrode comprising a conductive material, and the outer electrode configured with a plurality of apertures;
wherein the outer electrode sheaths the inner electrode such that a spacing exists between the outer electrode and the inner electrode;
a power supply configured to supply a voltage differential to the plurality of electrode assemblies;
an aqueous medium, the aqueous medium in physical contact with the plurality of electrode assemblies; and
a precipitate removal system configured to remove suspended solids from the surface of the aqueous medium, the suspended solids having been entrained to the surface of the aqueous medium by hydrogen gas.

13. The system of claim 12, wherein the non-donating material of the inner electrode further comprises platinum, ruthenium, rhodium, palladium, osmium, iridium, titanium, carbon, conductive plastic, or combinations thereof.

14. The system of claim 12, wherein the outer electrode comprises stainless steel, platinum, ruthenium, rhodium, palladium, osmium, iridium titanium, carbon, conductive plastic, or combinations thereof.

15. The system of claim 12, wherein the spacing is between about 1 mm to about 9 mm.

16. A method for removal of suspended solids and disinfection of an aqueous medium by electrolysis, the method comprising:
providing a plurality of electrode assemblies configured to generate hydrogen gas and halides, each electrode assembly comprising:
an inner electrode comprising a non-donating conductive material; and
an outer electrode configured to sheath the inner anode, the outer electrode comprising a conductive material, and the outer electrode configured with a plurality of apertures;
wherein the outer electrode sheaths the inner electrode such that a spacing exists between the outer electrode and the inner electrode;
contacting an aqueous medium with the plurality of electrode assemblies, the aqueous medium comprising suspended solids;
generating hydrogen gas and halides within the aqueous medium by supplying a voltage differential to the inner electrode and the outer electrode in the plurality of electrode assemblies;
disinfecting the aqueous medium with the halides;
entraining suspended solids to a surface of the aqueous medium with the hydrogen gas; and
removing suspended solids from the surface of the aqueous medium.

17. The method of claim 16, wherein the non-donating material of the inner electrode further comprises platinum, ruthenium, rhodium, palladium, osmium, iridium, titanium, carbon, conductive plastic, or combinations thereof.

18. The method of claim 16, wherein the outer electrode comprises stainless steel, platinum, ruthenium, rhodium, palladium, osmium, iridium titanium, carbon, conductive plastic, or combinations thereof.

19. The method of claim 16, wherein the spacing is between about 1 mm to about 9 mm.

20. The method of claim 16, wherein the apertures of the outer electrode are configured as a mesh.
